(19) United States
(12) Patent Application Publication
(10) Pub. No.: US 2002/0039523 A1
(43) Pub. Date: Apr. 4, 2002

(54) Fastener including a head and a shank at least partially including a threaded portion

(76) Inventors: Gunther Hartmann, Alsfeld (DE); Klaus Kirbach, Homberg/Ohm (DE); Hermann Kohler, Alsfeld (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/965,384

(22) Filed: Sep. 27, 2001

(30) Foreign Application Priority Data
Oct. 4, 2000 (DE) 100 48 918.4-12

(51) Int. Cl. F16B 23/00

(52) U.S. Cl. 411/403

(57) ABSTRACT

A fastener, especially a screw (1), includes a head (2) including an inner polygon (6). The inner polygon (6) has a design corresponding to a spline shaft and is formed by a plurality of tangential surfaces (7) substantially extending in a circumferential direction, a plurality of radial surfaces (8, 9) each being connected to one of the tangential surfaces (7) and a plurality of connecting surfaces (10) substantially extending in a circumferential direction and each connecting two radial surfaces (9, 8) being associated with adjacent tangential surfaces (7). Each of the connecting surfaces (10) has a bent design in the form of a circular arc and is convex in a direction towards the axis (5) for engagement of a hexagon wrench (14) of the standard range during emergency operation. The circular arc is formed by a circle formed by two first points (P₁) resulting from an intersection of the contour of the hexagon wrench (14) when it is symmetrically inserted into the inner polygon (6) after a turning movement of approximately 8 to 12 degrees and the radial surfaces (8, 9) of the inner polygon (6) and a third point (P₂) located in a tangential direction with respect to a circle having a diameter (D₂) about the axis (5). The diameter (D₂) is approximately 0.08 mm to 0.15 mm more than a diameter (D₃) of a minimum inner circle of the connecting surfaces (10) corresponding to a minimum inner circle of a hexagon hole of the hexagon wrench (14).

### CROSS REFERENCE TO RELATED APPLICATIONS

This application claims the benefit of co-pending German Patent Application No. 100 48 918 entitled “Verbindungselement mit einem Kopf und einem zumindest teilweise mit einem Gewinde versehenen Schaft”, filed on Oct. 4, 2000.

### FIELD OF THE INVENTION

The present invention generally relates to a fastener including a head and a shank at least partially including a threaded portion. More particularly, the present invention relates to a fastener, especially a screw, including a head including a recess in the form of an inner polygon.

### BACKGROUND OF THE INVENTION

The inner polygon of the head of the fastener includes a plurality of radial surfaces, or at least a plurality of surfaces approximately extending in a radial direction to be capable of applying great turning moments or torque during tightening of the fastener with a special wrench having a design corresponding to the design of the inner polygon of the head of the fastener. The pairs of radial surfaces may be designed and arranged to be parallel which is optimal for the transmittance of great turning moments with a special wrench.

In contrast to such screws including an inner polygon with the “spline shaft design” and edges, round inner hexagon screws are also known in the art. In these screws, the radial portion of the transmitting surface is designed to be relatively small.

Of course, usual inner hexagon screws including edges are well known in the art. These known screws may be tightened and loosened with a usual hexagon wrench taken from the standard range which includes six plane outer contacting surfaces.

These aforementioned screws—besides the inner hexagon screws—require a special wrench for normal operation, the special wrench having a design which corresponds to the design of the recess being located in the head of the screw. With such special wrenches, the screws may be well handled. However, in case the user does not have a special wrench handy, but only a usual hexagon wrench taken from the standard range, with some screws it is possible to conduct an emergency operation in the sense of using a wrench which was not designed for the screw. Anyway, the known round inner hexagon screws cannot be successfully tightened with such a usual hexagon wrench. They only allow for an insertion of a hexagon wrench which has a relatively small cross section. Consequently, there is the danger of the small hexagon wrench breaking or of the profile of the round inner hexagon screw being deformed.

A fastener is known from FIG. 2 of European Patent No. 0 670 431 B1. This prior art document also describes the three types of prior art screws having a recess being located in the head of the screw, namely usual hexagon screws, a screw including an inner polygon having a shape corresponding to a spline shaft and a round inner hexagon screw. The inner polygon screws are supposed to be operated with a hexagon wrench taken from the standard range during emergency operation, meaning when no corresponding special tool is available. Connecting surfaces are located between the radial surfaces of adjacent tabs of the known inner polygon. The connecting surfaces have a straight and plane design. In case such a known screw is operated with a usual hexagon wrench taken from the standard range during emergency operation, there is the danger of the profile of the known inner polygon being deformed in the transition region between the connecting surfaces and the radial surfaces such that a following operation with a special wrench is no longer possible. To counteract this problem, according to FIG. 4 of European Patent No. 0 670 431 B1, the connecting surface between two radial surfaces (which are arranged to be parallel and substantially radial) of two tabs are designed and arranged to be inclined in a roof-like manner in a way that two plane surfaces or portions are located between each pair of adjacent tabs. The two inclined surfaces or portions at the head of the screw form a regular polygon both in the tightening direction and in the loosening direction. Imaginary projections of the inclined surfaces of adjacent inclined surfaces of one and the same regular polygon do not intersect. Emergency operation of such a known screw with a usual hexagon wrench is only possible when the hexagon wrench may also be inserted in the tab-like recess being located in the head of the screw. A hexagon wrench having maximum dimensions and which may just be inserted into such a tab-like recess has a size corresponding to the distance between the intersection edges of the plane surfaces or portions at each connecting surface. When such a hexagon wrench is inserted, it theoretically cannot not be turned with respect to the screw. There is line contact between the wrench and the intersection edges. Torque may only be applied under frictional contact usually not being sufficient to loosen the screw. However, when a hexagon wrench having smaller dimensions is inserted into the interior of the known inner polygon—which is possible without problem and which is the usual case—such a smaller wrench may be turned inside the interior before torque is applied. Nevertheless, the turning movement without transmitting forces ends under line contact of the plane surfaces of the hexagon wrench in the transition region between the connecting surfaces and the radial surfaces of the known inner polygon such that the transition region will still be deformed during emergency operation when torque is applied. Theoretically, a hexagon wrench having dimensions such that it contacts the inclined plane surfaces of the connecting surface in a plane manner is imaginable. However, such plane contact is very unlikely since such a hexagon wrench very rarely occurs in the standard range of hexagon wrenches and, additionally, the inner polygon may only be produced with a tolerance. Plane contact between said two plane surfaces only takes planes in the unlikely corresponding combination of tolerances of the inner polygon and the hexagon wrench. Practically, one has to assume that during emergency operation with a hexagon wrench taken from the standard range, there always exists play between the contour of the head and the hexagon wrench. During emergency operation, line contact occurs between the elements. Consequently, the transition region between the connecting surfaces and the radial surfaces of the inner polygon is deformed. In case of relatively small play existing between the hexagon wrench and the connecting surfaces of the inner polygon, the disadvantageous shearing off effect occurs in the middle region of the connecting surface in combination with the loose turning movement of the hexagon wrench across the deformed intersection edge of the two inclined surface portions of the connecting surface.

European Patent Application No. 0 430 543 A1 shows a fastener including a head and a shank at least partially including a threaded portion. The head includes a depression being formed by an inner polygon corresponding to a spline shaft design. The inner polygon includes five or six outwardly protruding recesses. The inner polygon includes tangential surfaces being directed in the circumferential direction. The tangential surfaces are formed by tangents of two small circles, and they are located on a circumference about the center of the inner polygon. Surfaces in the form of circular arcs being formed by the circumferential surfaces of the small circles are connected to the tangential surfaces. The known inner polygon does not include connecting surfaces extending in the circumferential direction. The connecting surfaces are arranged as bent surfaces in the form of circular arcs which are formed by comparatively great hypothetical circles the centers of which are located on the circumferential line of the tangential surfaces. Hypothetical pentagons or hexagons are formed by the centers of the two kinds of circles. The portions in the form of circular arcs of the outwardly directed recesses are connected between the pentagons or hexagons by straight surface portions being arranged to be tangential with respect to the two kinds of circles. Disadvantageously, the straight surface portions only have a comparatively short extension in a radial direction for the transmittance of torque with a corresponding special wrench. They are not connected to the outer tangential surfaces, but they are located on a smaller radius further inside in a radial direction. The contact occurring during tightening of such a known fastener with a correspondingly designed special tool is to be realized as line contact occurring in the region of the straight surface portions. Allowable tolerances only have the effect of the line contact moving within the short portion of the radial extension of the plane surface portions. The driving angle does not change during this movement. In this way, the effective transmittance of torque between the special tool and the known fastener only varies within a comparatively small range. Consequently, there is the advantage of the applicable torque only varying with in a small range during normal operation, meaning that it remains substantially constant. However, it is disadvantageous that the radius which may theoretically be used to the outer tangential surfaces practically is not used for the transmittance of torque and instead line-like contact between the elements is used for the transmittance of torque. The known fastener is not designed to be operated with a hexagon wrench taken from the standard range during emergency operation. However, the design of the contour of the two types of circles only allows for an insertion of a relatively small hexagon wrench resulting in the danger of the hexagon wrench turning loose.

German Patent Application No. 17 28 574 shows a fastener including a head and a shank including a threaded portion. The head includes a recess in the form of an inner polygon in the form of a spline shaft. The contour of the inner polygon is formed by two hypothetical circles tangentially changing into each other. The bigger circle at least has twice the radius of the smaller circle. There are no tangential surfaces being directed in a circumferential direction, and no radial surfaces being substantially directed in a radial direction. It is to be understood that the centers of the smaller circles are located on the corners of a first hexagon and that the centers of the bigger circles are located on the corners of a second hexagon. The known fastener is to be operated by a correspondingly designed special wrench. Emergency operations using a usual hexagon wrench are not desired.

Another fastener in the form of a screw is known from U.S. Pat. No. 2,969,250. The head of the known screw includes an inner polygon in the form of a spline shaft which is arranged about the axis of the screw in a point-symmetrical manner. The known inner polygon includes tangential surfaces being directed in a circumferential direction. The tangential surfaces are directly interconnected—without any radial surfaces—by connecting surfaces having the shape of circular arcs. The circles of the connecting surfaces in the shape of circular arcs are defined by two points being formed by the end points of adjacent tangential surfaces. The third point of the circles is determined as tangential point with respect to the inner circle of such a hexagon wrench the corners of which are located on the circle forming the tangential surfaces. As usual, the diameter of the inner circle corresponds to the wrench size of the hexagon. The circle forming the connecting surfaces in the form of circular arcs has a radius corresponding to the diameter of the wrench size. The known fastener has the disadvantage that—during normal operation with a special wrench—torque may only be transmitted under line contact and, consequently, there is the danger of the wrench turning loose or shearing off effects occurring. On the other hand—during emergency operation—only hexagon wrenches of the standard range which can be inserted into the interior of the inner polygon may be used. A lot of these usual hexagon wrenches will contact the middle region of the connecting surface in the form of a circular arc during turning movement in a way that there is the danger of the wrench turning loose.

### SUMMARY OF THE INVENTION

The present invention generally relates to a fastener including a longitudinal axis, a head including an inner polygon being located point-symmetrically about the axis and a shank at least partially including a threaded portion. More particularly, the present invention generally relates to a fastener including an inner polygon having a design corresponding to a spline shaft and being formed by a plurality of tangential surfaces substantially extending in a circumferential direction, a plurality of radial surfaces each being connected to one of the tangential surfaces and a plurality of connecting surfaces substantially extending in a circumferential direction and each connecting two radial surfaces being associated with adjacent tangential surfaces. The connecting surfaces each have a bent design in the form of a circular arc and are designed and arranged to be convex in a direction towards the axis for engagement of a hexagon wrench of the standard range during emergency operation. The circular arc is formed by a circle which is formed by two first points resulting from an intersection of the contour of the hexagon wrench when it is symmetrically inserted into the inner polygon after a turning movement of approximately 8 degrees to 12 degrees and the radial surfaces of the inner polygon and a third point being located in a tangential direction with respect to a circle having a first diameter about the axis. The first diameter is approximately 0.08 mm to 0.15 mm more than a second diameter of a minimum inner circle of the connecting surfaces corresponding to a minimum inner circle of a hexagon hole of the standard range being associated with the hexagon wrench. The present invention relates to a novel fastener being adapted to be operated with a usual hexagon wrench during emergency operation. It does not relate to the hexagon wrench itself.

The novel fastener may be reliably loosened and tightened with a hexagon wrench taken from the standard range—meaning a usual hexagon wrench with a usual hexagon cross section—during emergency operation without the danger of the transition region between the connecting surfaces and the radial surfaces of the inner polygon being deformed. Additionally, the novel fastener including an inner polygon in the shape of a spline shaft may be operated with a respective special wrench without deforming the surfaces associated with the emergency operation. The design of the inner polygon corresponds to a spline shaft in the sense of including surfaces which extend parallel to its axis.

The connecting surfaces being located between the inner ends of the radial surfaces of adjacent recesses or tabs of the inner polygon are designed as cylindrical surfaces, and they have a cross section in the form of a portion of a circular arc. The circle forming the circular arc has a center usually being located outside the head surface of the fastener. More particularly, it is located on a line connecting the axis of the screw and the center of the respective connecting surface. Such a circle is formed and mathematically determined, respectively, by three points. The first two points are constructed as follows. One starts from the contour of a hexagon wrench of the standard range. Especially, one starts from the contour being formed by the greatest allowable hexagon wrench within the tolerance range. Such a hexagon wrench may be inserted into the inner polygon in way that the corners of the hexagon wrench are located in the middle of the tab-like recesses at half the distance between the two radial surfaces of a tab. The contour of the hexagon wrench will then be turned by approximately 8 degrees to 12 degrees, preferably by 10 degrees. The two first points result as intersecting points of the turned contour of the hexagon wrench having the greatest design within the tolerance range and the radial surfaces. These two first points form a boundary region in which a line-like support of the hexagon wrench at the transition region between the radial surfaces and the connecting surfaces takes place. The boundary is to be met and to be prevented, respectively. The effective support between a hexagon wrench taken from the standard range and the transition region is desired to take place adjacent to the edge of the transition region in the adjacent region of the connecting surfaces. Consequently, there is a free space and a free surface, respectively, between normal operation and emergency operation which is neither used during normal operation nor during emergency operation. Emergency operation only takes place with a flat, plane contact of a middle region of a side surface of the hexagon wrench and a supporting region being located at the connecting surface having the shape of a circular arc. The question at which position the plane contact takes place and what dimensions the plane contact has depends on the dimensions of the circle and on the position of the third point of the circle. The contour of the hexagon wrench taken from the standard range also determines the position of this third point to some extent. However, more particularly, the contour of the hexagon hole being associated with the hexagon wrench determines the position of the third point. Starting from a diameter of the minimum inner circle of the hexagon hole within the determined tolerance range, a diameter of a circle about the axis of the fastener is determined. The later diameter is approximately 0.08 mm to 0.15 mm more than the first diameter. The diameter of the circle tangentially touches the circle to be determined the center of which is located outside the head surface of the screw. The third point is the touching point of these two circles. The intersecting point of the mid-perpendicular between two of the aforementioned points is the center point of the circuit determining the contour of the connecting surface in the form of a circular arc. The position of the third point allows for all hexagon wrenches within the tolerance range and taken from the standard range may be inserted into the interior of the inner polygon and may be turned without transmitting forces until the hexagon surfaces of the hexagon wrench reach and contact the connecting surface being located between the adjacent recesses of the inner polygon. The place of contact is located at a rather great distance from the middle of the respective connecting surface. Additionally, it is located slightly away from the transition region being located between the connecting surfaces and the radial surfaces. In this way, depending on the combination of tolerances, a bent surface having the design of a circular arc contacts a hexagon surface of the hexagon wrench having a more or less plane and flat design. When torque is applied during emergency operation, the line-like contact enlarges to a plane contact under a corresponding reduction of the surface pressure.

The connecting surface being located between two radial surfaces being connected to adjacent tangential surfaces does no longer have a plane design as known in the prior art. It neither has a plane design in the sense of a plane, continuous surface nor as two inclined, plane, roof like surfaces. Instead, the connecting surface of the novel fastener is designed as a bent surface in the form of a circular arc which is convex towards the inside. In this way, it is ensured that the plane surfaces of a hexagon wrench and the bent, convex connecting surfaces in the form of a circular arc contact one another during emergency operation with a hexagon wrench taken from the standard range. When these surfaces start to contact one another at the end of the turning movement of the hexagon wrench without transmitting forces, there only is line contact. In accordance with the Hertz Theory, the line contact changes to surface contact due to elastic deformation of the elements in case of increasing torque. The plane contact between the elements during the transmittance of torque during emergency operation always occurs independent from the combination of the hexagon wrench and the connecting surfaces of the inner polygon in the shape of a circular arc being manufactured with tolerances. The elastic deformation always generates plane contact such that a sufficiently great surface for transmitting torque is available without the danger of the hexagon wrench turning loose or breaking and without the danger of deformation occurring between the connecting surfaces and the radial surfaces of the inner polygon.

In case the design of the bent connecting surface in the form of a circular art is chosen such that the fastener may also be tightened with the special tool known for use with prior art screws, there is the further advantage that such a fastener may also be tightened with a hexagon round wrench of a respective size. Thus, such a fastener may not only be tightened during a first emergency operation with a hexagon edge wrench of the standard range, but also during a second emergency operation with an available hexagon round wrench.

To be capable of tightening the screw according to FIG. 4 of European Patent No. 0 670 431 B1 with the respective special wrench, the geometric conditions described in European Patent No. 0 670 431 B1 have to be also fulfilled in the novel bent connecting surfaces having the shape of a circular arc. Depending on the combination of tolerances of the hexagon wrench and of the inner polygon, the center of the surface-like or plane bearing surface or supporting surface will change its location. In case of low play existing between the elements, the supporting surface will be located further away from the tangential surface of the tab-like recess than in case of comparatively great play or looseness existing between the elements.

In case the first point (P₁) is determined as intersecting point of the contour of the hexagon wrench when it is symmetrically inserted into the inner polygon after a turning movement of approximately 10 degrees and the radial surfaces of the inner polygon, the tolerances unpreventably occurring between the interior of the inner polygon including the connecting surfaces having the shape of a circular arc and the plane connecting surfaces being located at the outer circumference of the hexagon wrench taken from the standard range may be well controlled. The interior is big enough to easily insert the respective hexagon wrench with its nominal size without the danger of the hexagon wrench turning loose during emergency operation. On the other hand, the contact surface of the plane supporting surface is located on a relatively great radius without reaching the transition region between the connecting surface and the radial surfaces.

The diameter (D₂) of the circle forming the third point (P₂) may be approximately 0.1 mm more than the diameter (D₃) of the minimum inner circle of the hexagon hole being associated with the hexagon wrench. This also is a preferred way of dimensioning.

In case there are rounded transitions between the connecting surfaces and the radial surfaces, the desired plane supporting surface is realized as it is advantageous for the transmittance of great turning moments even when a relatively small hexagon wrench is used, meaning even when relatively great looseness exists between the wrench and the screw.

In case there are rounded transitions between the tangential surfaces and the radial surfaces, notch tension is prevented and limited, respectively, especially during normal operation.

The bent design in the form of a circular arc of the connecting surfaces may be arranged at least in two regions of the connecting surfaces in a direction from the first points (P₁) towards the third point (P₃) in a way that these regions of the convex connecting surfaces of the inner polygon of the head of the novel fastener contact plane surfaces of a hexagon wrench when a hexagon wrench taken from the standard range is used during emergency operation. It is not necessary that the contour of the connecting surfaces in the shape of a circular arc is designed to be continuous in its middle region. There is no support or contact in the middle region of the connecting surfaces during emergency operation. The middle regions may also be designed as straight or plane surfaces. However, the design in the shape of a continuous circular arc has the advantage that the production tools for the manufacture of such a novel fastener are comparatively easy to produce.

In call cases, the radius of the circle forming the connecting surface should be dimensioned and arranged such that each convex connecting surface of the inner polygon of the novel fastener contacts a plane surface of the hexagon wrench during use of the hexagon wrench taken from the standard range during emergency operation. Due to the realization of the plane supporting surface for all existing combinations of tolerances between the hexagon wrench and the inner polygon, the danger of the hexagon wrench turning loose or breaking during emergency operation is prevented.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a top view of the head of the novel fastener with an inserted hexagon wrench during emergency operation.

FIG. 2 is a similar view of the fastener with a rounded transition region being located between the connecting surface and the radial surface.

FIG. 3 is an enlarged detailed view of the fastener according to FIG. 1.

FIG. 4 is a further enlarged detailed view of the fastener according to FIG. 1.

FIG. 5 is a view illustrating the construction principles of the connecting surfaces having the shape of circular arcs.

### DETAILED DESCRIPTION

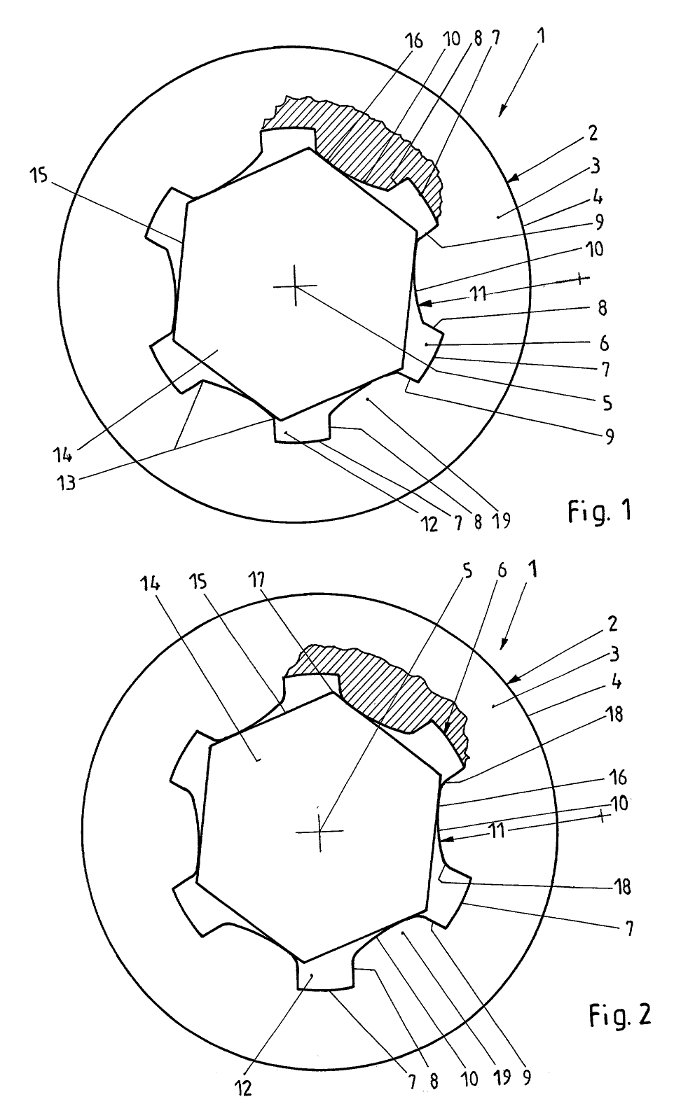

Referring now in greater detail to the drawings, FIG. 1 illustrates a novel fastener in the exemplary embodiment of a screw 1. Due to the top view of FIG. 1, only the head 2 including a front surface 3 and a circumferential surface 4 are illustrated, while the shank of the screw I including a threaded portion is located behind the plane of illustration and cannot be seen. The screw 1 includes an axis 5 which extends perpendicular with respect to the plane of illustration.

An inner polygon 6 is located in the head 2 of the screw 1. The inner polygon 6 has the shape of a spline shaft, and—starting from the free front surface 3—it extends into the head 2 to a certain depth. The inner polygon 6 includes a majority of individual surfaces which extend parallel to the axis 5 and, consequently, also parallel to the circumferential surface 4. These individual surfaces are not designed to be conical, or they only have a limited conical form resulting from the production process and which is neglectable. The inner polygon 6 includes tangential surfaces 7 which in this case have the design of circular arcs and which extend in the circumferential direction. A radial surface 8 is connected to the left side of each tangential surface 7, and a radial surface 9 is connected to the right side of each tangential surface 7. In the illustrated embodiment, the radial surfaces 8 and 9 extend parallel to each other. This means that they do not extend exactly radial with respect to the axis 5. However, the radial surfaces 8 and 9 may be arranged to be exactly radial with respect to the axis 5. A connecting surface 10 is located between two adjacent tangential surfaces 7 and between their radial surfaces 9 and 8 facing each other, respectively. In the illustrated embodiment, the connecting surface 10 has a radius 11 the center of which usually is located outside the circumferential surface 4 of the head 2. In this way, the connecting surface 10 attains its shape of a circular arc which extends in a convex way from the outside towards the inside, meaning with respect to the axis 5. The radial surfaces 8 and 9 in combination with one tangential surface 7 form an outwardly directed recess or a tab 12 which is a component of the hollow space being surrounded by the inner polygon 6. The radial surfaces 8 and 9 in combination with a connecting surface 10 form a tab 19 which extends in a radial direction from the outside towards the inside. The tab 19 is not part of the hollow space, but it is designed to include material.

The connecting surfaces 10 are designed to be bent in the form of circular arcs. An edge 13 is located at each transition between the connecting surface 10 and the adjacent radial surfaces 8 and 9, respectively.

The inner polygon 6 having the shape of a spline shaft serves for the engagement of a special wrench which has a similar profile or contour as the inner polygon 6. It is to be understood that the contour of the wrench is slightly smaller to allow for a certain play or clearance. With such a special wrench tool, the screw 1 is tightened and loosened during normal operation.

However, in case such a special wrench tool is not available, a hexagon wrench 14 may be used in the sense of an emergency operation. The hexagon wrench 14 includes six plane surfaces 15. The hexagon wrench 14 is taken from the standard range. The inner polygon 6 is designed and arranged to cooperate with the profile of the hexagon wrench 14. After the hexagon wrench 14 has been inserted into the inner polygon 6, the hexagon wrench 14 may be turned without applying forces. FIG. 1 illustrates the turning movement in the tightening direction in combination with a usual right-handed thread. At the end of this turning movement, the plane surfaces 15 contact the bent connecting surfaces 10 under line contact. This condition is illustrated in FIG. 1 and also in FIG. 3 at enlarged scale. The contact takes place along a line 16. As soon as torque is applied—in this case in the tightening sense of direction deformation takes place in the region of the line 16 in a way that the line 16 changes to a more or less extended plane contact between the plane surfaces 15 and the respective connecting surface 10. Due to this plane contact, surface pressure is reduced. There is no danger of the edge 13 being located at the transition between the connecting surface 10 and the radial surface 9 being permanently deformed. It is also to be seen that the hexagon wrench 14 with its edge 17 neither contacts the edge 13 nor the connecting surface 10. The plane support existing between the surface 15 and the connecting surface 10 will build up around the line 16. This is true for the tightening movement of the screw 1. It is to be understood that during the loosening movement of the screw 1, the plane contact will be realized symmetrically at a different place with respect to the connecting surface 10. The line 16 and plane contact resulting from the application of forces will be realized at different locations of the connecting surface 10 depending on the tolerances of the connecting surface 10 being located at the screw 1 and the tolerances of the surfaces 15 being located at the hexagon wrench 14. One may realize a geometric shape of these elements and processing tolerances at which neither the edges 13 nor the edges 17 get in contact with the respective other elements. In this way, the plane support being realized under the effects of torque will be maintained during all conditions.

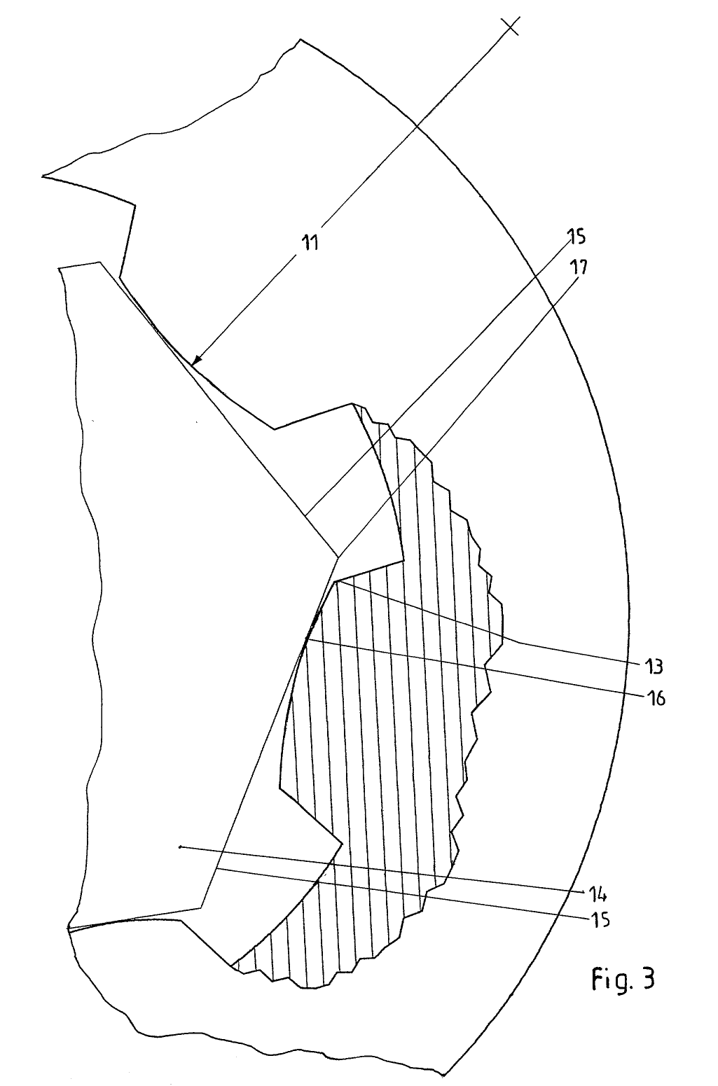

FIG. 2 illustrates another exemplary embodiment of the novel screw 1. Since this embodiment to a great extent has a similar structure as the embodiments of FIGS. 1 and 3, it is referred to the preceding description. The inner polygon 6 of the novel screw I as illustrated in FIG. 2 does not include the edges 13. The transition between the connecting surface 10 and the respective radial surface 8 and 9, respectively, is formed by a rounded surface 18 which continuously changes into the connecting surface 10 having the shape of an circular arc.

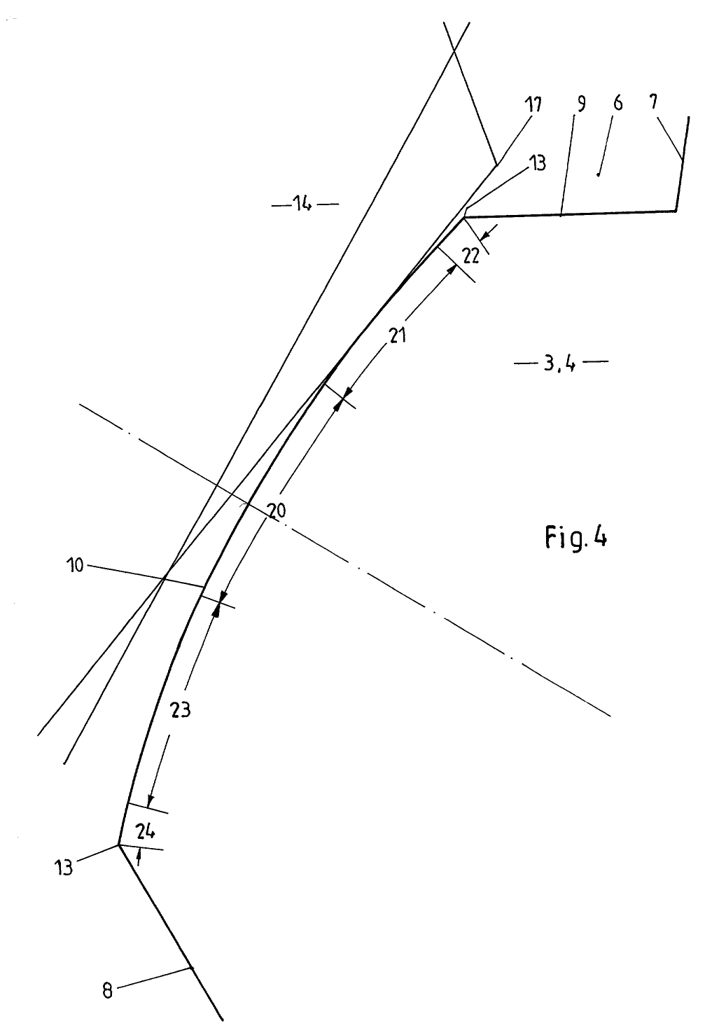

FIGS. 3 and 4 illustrate the plane support of the plane side surfaces of the hexagon wrench 14 at the cylindrical contour of the connecting surface 10 of the inner polygon 6. It is to be seen from these Figures that a plane support results from the application of torque. The surfaces getting in contact with one another do not contact the edge 13 being located between the connecting surface 10 and the radial surface 9 and a transition region being formed by the rounded surface 18. The support or contact takes place adjacent to the edge 13 and at a desirably great radius. A free space at which no contact takes place is realized at the edge 13 and at the transition region, respectively. Furthermore, a middle region 20 is free from any contact such that the middle region 20 may have a plane, flattened shape. Taking the tolerance ranges of the contour of the hexagon wrench 14 and of the respective hexagon hole into account, one attains a supporting region 21 in which the support or contact takes place. Depending on the combination of tolerances, the support will take place further outside or further inside the supporting region 21. A free space 22 next to the edge 13 remains free from contact. With respect to a supporting region 23 and a free space 24, the same is true for the loosening or untightening movement of the screw 1.

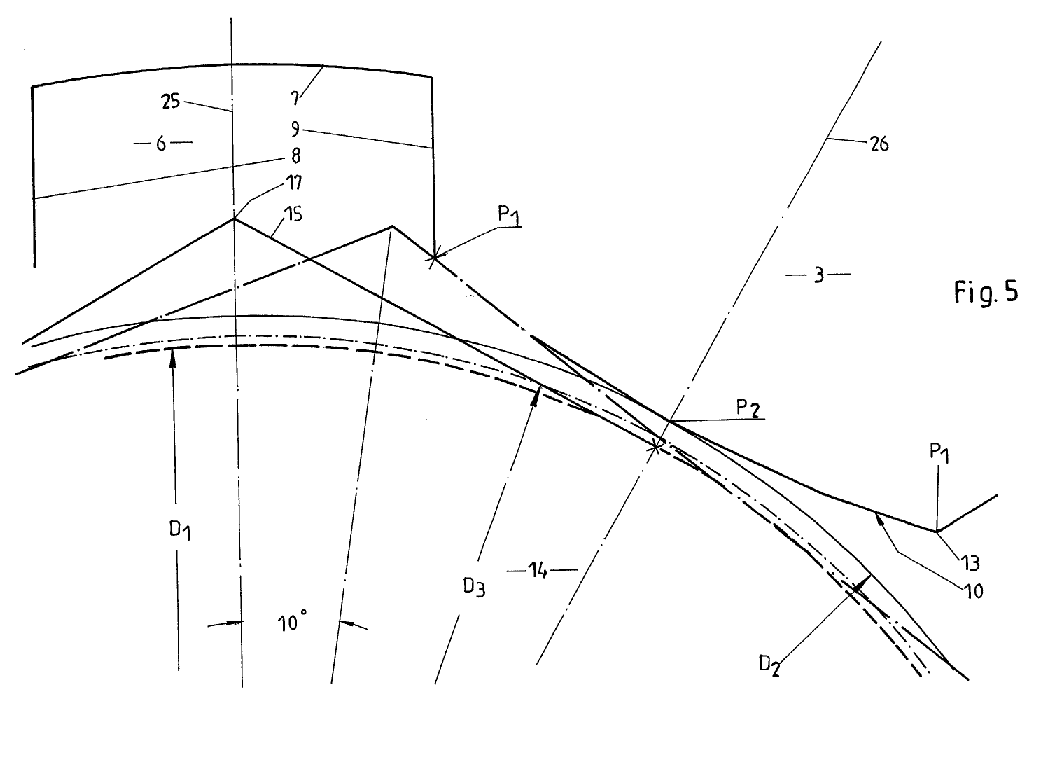

Referring now to FIG. 5, the construction principle for the design of the contour of the connecting surface 10 having the shape of a circular arc or of a cylinder jacket will be explained. The starting point is a given contour of the inner polygon 6 with the positions of the tangential surfaces 7 and the radial surfaces 8 and 9 being connected thereto. In this way, especially the width of the tap-like recesses of the inner polygon 6—meaning the distance between two associated radial surfaces 8 and 9—is determined. For example, the width is chosen in view of the turning moments to be transmitted and of the occurring shear stress of such an outwardly protruding tooth of a special wrench tool. The hexagon wrench 14 is now inserted into the partly determined inner polygon 6 in a way that its edges 17 are located exactly on the symmetric lines 25. The tap-like recesses of the inner polygon 6 are symmetric with respect to the symmetric lines 25. The hexagon wrench 14 includes an inner circle having the diameter D₁. Especially, one chooses the contour of the greatest allowable hexagon wrench 14 being taken from the tolerance range of the standard range. The dash-dotted contour of the hexagon wrench 14 with its surfaces 15 results from a turning movement of the hexagon wrench 14 about the axis 5 by approximately 10 degrees. The surfaces 15 intersect the radial surfaces 9 and 8 in a mirror-like arrangement and turning movement about 10 degrees in the other sense of rotation, respectively. Depending on the dimensions of the screw 1 and the design of the tap-like recess of the inner polygon 6, the turning movement may be in a range of approximately 8 to 12 degrees. In this way, two points P₁ of the connecting surface 10 are determined. These two points P₁ are part of a circle and of a cylinder respectively, the center M of which is located outside the head 2 of the screw 1 on a center line 26 and which has a radius 11.

A third point P₂ is necessary to determine the position of the center point M and the radius 11 of the circle. One starts from a diameter D₃ about the axis 5 of the inner polygon 6 to determine the position of this third point P₂. The diameter D₃ is the diameter of the smallest inner hole of the hexagon hole of the hexagon wrench 14 corresponding to the tolerance range. In this way, it is ensured that all hexagon wrenches 14 may be inserted into the inner polygon 6 corresponding to their allowable tolerance range. A diameter D₂ about the axis 5 of the screw 1 is determined to prevent substantially useless support in the middle region 20 of the connecting surface 10. The diameter D₂ approximately is 0.08 mm to 0.15 mm more than the diameter D₃. Depending on the dimensions of the screw 1, especially good results are attained if the diameter D₂ is approximately 0.1 mm more than the diameter D₃. The point P₂ is the intersecting point between the circle and the diameter D₂ and the center line 26. The point P₂ serves as third point to determine the circle. In other words, the circles with the radius 11 and with the diameter D₂ contact in a tangential direction along a line through the point P₂.

The following data for an exemplary embodiment corresponding to a hexagon wrench 14 of the wrench size SW 8 DIN 7422 serves to make the preceding description even more clear:

The diameter D₁ is 8.000 mm. Corresponding to the allowable tolerance range for such an inner hexagon wrench 14, the diameter D₁ may vary between D_{1 min}=7.942 mm and D_{1 max}8.000 mm. In case of a width of the tap-like recess—meaning a distance b of the radial surfaces 8 and 9 with respect to one another—of, for example, approximately b=1.9 mm, the point P₁ is located on a diameter of 9.28 mm.

The diameter D₃ of a corresponding hexagon hole may vary between D_{3 min}=8.06 mm and D_{3 max}=8.12 mm. Assuming a value of D₃=8.10 mm and adding the value of approximately 0.1 mm, D₂ equals 8.20 mm. Consequently, there is a circle about the center point M which has the radius 11=3.56 mm.

Many variations and modifications may be made to the preferred embodiments of the invention without departing substantially from the spirit and principles of the invention. All such modifications and variations are intended to be included herein within the scope of the present invention, as defined by the following claims.

We claim:

1. A fastener comprising:
an axis (5);
a head (2) including an inner polygon (6) being located point-symmetrically about the axis (5), said inner polygon (6) having a design corresponding to a spline shaft and being formed by
a plurality of tangential surfaces (7) substantially extending in a circumferential direction,
a plurality of radial surfaces (8, 9) each being connected to one of said tangential surfaces (7), and
a plurality of connecting surfaces (10) substantially extending in a circumferential direction and each connecting two radial surfaces (9, 8) being associated with adjacent tangential surfaces (7), said connecting surfaces (10) each having a bent design in the form of a circular arc and being designed and arranged to be convex in a direction towards the axis (5) for engagement of a hexagon wrench of the standard range during emergency operation, the circular arc being formed by a circle which is formed by
two first points (P₁) resulting from an intersection of the contour of the hexagon wrench when it is symmetrically inserted into said inner polygon (6) after a turning movement of approximately 8 degrees to 12 degrees and said radial surfaces (8, 9) of said inner polygon (6), and
a third point (P₂) being located in a tangential direction with respect to a circle having a diameter (D₂) about the axis (5), the diameter (D₂) being approximately 0.08 mm to 0.15 mm more than a diameter (D₃) of a minimum inner circle of said connecting surfaces (10) corresponding to a minimum inner circle of a hexagon hole of the standard range being associated with the hexagon wrench; and
a shank at least partially including a threaded portion.

2. The fastener of claim 1, wherein the first point (P₁) is determined as intersecting point of the contour of the hexagon wrench when it is symmetrically inserted into said inner polygon (6) after a turning movement of approximately 10 degrees and said radial surfaces (8, 9) of said inner polygon (6).

3. The fastener of claim 1, wherein the diameter (D₂) of the circle forming the third point (P₂) is approximately 0.1 mm more than the diameter (D₃) of the minimum inner circle of the hexagon hole being associated with the hexagon wrench.

4. The fastener of claim 2, wherein the diameter (D₂) of the circle forming the third point (P₂) is approximately 0.1 mm more than the diameter (D₃) of the minimum inner circle of the hexagon hole being associated with the hexagon wrench.

5. The fastener of claim 1, further comprising transitions between said connecting surfaces (10) and said radial surfaces (8, 9), said transitions having a rounded design.

6. The fastener of claim 2, further comprising transitions between said connecting surfaces (10) and said radial surfaces (8, 9), said transitions having a rounded design.

7. The fastener of claim 3, further comprising transitions between said connecting surfaces (10) and said radial surfaces (8, 9), said transitions having a rounded design.

8. The fastener of claim 4, further comprising transitions between said connecting surfaces (10) and said radial surfaces (8, 9), said transitions having a rounded design.

9. The fastener of claim 1, further comprising transitions between said tangential surfaces (7) and said radial surfaces (8, 9), said transitions having a rounded design.

10. The fastener of claim 2, further comprising transitions between said tangential surfaces (7) and said radial surfaces (8, 9), said transitions having a rounded design.

11. The fastener of claim 3, further comprising transitions between said tangential surfaces (7) and said radial surfaces (8, 9), said transitions having a rounded design.

12. The fastener of claim 4, further comprising transitions between said tangential surfaces (7) and said radial surfaces (8, 9), said transitions having a rounded design.

13. The fastener of claim 5, further comprising transitions between said tangential surfaces (7) and said radial surfaces (8, 9), said transitions having a rounded design.

14. The fastener of claim 6, further comprising transitions between said tangential surfaces (7) and said radial surfaces (8, 9), said transitions having a rounded design.

15. The fastener of claim 7, further comprising transitions between said tangential surfaces (7) and said radial surfaces (8, 9), said transitions having a rounded design.

16. The fastener of claim 8, further comprising transitions between said tangential surfaces (7) and said radial surfaces (8, 9), said transitions having a rounded design.

17. The fastener of claim 1, wherein the bent design in the form of a circular arc of said connecting surfaces (10) is arranged at least in two regions of said connecting surfaces (10) in a direction from the first points (P₁) towards the third point (P₃) in a way that these regions of said convex connecting surfaces (10) of said inner polygon (6) contact plane surfaces of a hexagon wrench when a hexagon wrench taken from the standard range is used during emergency operation.

18. The fastener of claim 2, wherein the bent design in the form of a circular arc of said connecting surfaces (10) is arranged at least in two regions of said connecting surfaces (10) in a direction from the first points (P₁) towards the third point (P₃) in a way that these regions of said convex connecting surfaces (10) of said inner polygon (6) contact plane surfaces of a hexagon wrench when a hexagon wrench taken from the standard range is used during emergency operation.

19. The fastener of claim 3, wherein the bent design in the form of a circular arc of said connecting surfaces (10) is arranged at least in two regions of said connecting surfaces (10) in a direction from the first points (P₁) towards the third point (P₃) in a way that these regions of said convex connecting surfaces (10) of said inner polygon (6) contact plane surfaces of a hexagon wrench when a hexagon wrench taken from the standard range is used during emergency operation.

20. The fastener of claim 4, wherein the bent design in the form of a circular arc of said connecting surfaces (10) is arranged at least in two regions of said connecting surfaces (10) in a direction from the first points (P₁) towards the third point (P₃) in a way that these regions of said convex connecting surfaces (10) of said inner polygon (6) contact plane surfaces of a hexagon wrench when a hexagon wrench taken from the standard range is used during emergency operation.

21. The fastener of claim 5, wherein the bent design in the form of a circular arc of said connecting surfaces (10) is arranged at least in two regions of said connecting surfaces (10) in a direction from the first points (P₁) towards the third point (P₃) in a way that these regions of said convex connecting surfaces (10) of said inner polygon (6) contact plane surfaces of a hexagon wrench when a hexagon wrench taken from the standard range is used during emergency operation.

22. The fastener of claim 9, wherein the bent design in the form of a circular arc of said connecting surfaces (10) is arranged at least in two regions of said connecting surfaces (10) in a direction from the first points (P₁) towards the third point (P₃) in a way that these regions of said convex connecting surfaces (10) of said inner polygon (6) contact plane surfaces of a hexagon wrench when a hexagon wrench taken from the standard range is used during emergency operation.

23. The fastener of claim 1, wherein said radial surfaces (7) are arranged to be approximately radial.

24. The fastener of claim 1, wherein said radial surfaces (7) are arranged to be approximately parallel.

25. The fastener of claim 1, wherein said fastener is a screw. 26. A fastener comprising:
an axis;
a head including an inner polygon being located point-symmetrically about the axis, said inner polygon having a design corresponding to a spline shaft and being formed by a plurality of tangential surfaces substantially extending in a circumferential direction,
a plurality of radial surfaces each being connected to one of said tangential surfaces, and
a plurality of connecting surfaces substantially extending in a circumferential direction and each connecting two radial surfaces being associated with adjacent tangential surfaces, said connecting surfaces each having a bent design in the form of a circular arc and being designed and arranged to be convex in a direction towards the axis for engagement of a hexagon wrench of the standard range during emergency operation, the circular arc being formed by a circle which is formed by
two first points resulting from an intersection of the contour of the hexagon wrench when it is symmetrically inserted into said inner polygon after a turning movement of approximately 8 degrees to 12 degrees and said radial surfaces of said inner polygon, and
a third point being located in a tangential direction with respect to a circle having a first diameter about the axis, the first diameter being approximately 0.08 mm to 0.15 mm more than a second diameter of a minimum inner circle of said connecting surfaces corresponding to a minimum inner circle of a hexagon hole of the standard range being associated with the hexagon wrench; and
a shank at least partially including a threaded portion.
